(19) United States
(12) Patent Application Publication
(10) Pub. No.: US 2019/0315511 A1
(43) Pub. Date: Oct. 17, 2019

(54) CONTAINER WITH ROUNDED CORNER OR CORNERS

(71) Applicant: Georgia-Pacific Corrugated LLC, Atlanta, GA (US)

(72) Inventors: Chester Denny Lee Garner, Richmond, IN (US); David Kent Balser, Cambridge City, IN (US)

(21) Appl. No.: 15/952,750

(22) Filed: Apr. 13, 2018

(51) Int. Cl. B65D 5/02; B65D 5/42; B32B 3/28; B32B 29/08; B32B 29/00

(52) U.S. Cl. CPC B65D 5/0209; B65D 5/4266; B32B 3/28; B65D 65/403; B32B 29/005; B65D 5/0254; B32B 29/08

(57) ABSTRACT

A container includes: a plurality of panels integrally arranged with respect to each other via a plurality of fold, score, or perforated lines, being formed from a fluted corrugated sheet product material, and being foldable to create the container; the plurality of panels having a plurality of planar panels, and a curved panel; the corrugated sheet product material having an inner facing, an outer facing, and a corrugated material therebetween; the inner facing of the curved panel having a plurality of side by side cuts or scores, wherein each of the plurality of side by side cuts or scores pierce at least partially through the inner facing but not through the outer facing; wherein the plurality of side by side cuts or scores extend substantially from one side of the curved panel to substantially an opposing side of the curved panel.

### BACKGROUND OF THE INVENTION

The present disclosure relates generally to a container, and particularly to a container having one or more rounded corners.

Packing containers are often formed from a corrugated sheet product material that is cut with a die to form one or more flat blanks, or scored and slotted to form a flat blank. The flat blank is folded into a three-dimensional container that may be secured using an arrangement of flaps, adhesive liquids, staples or adhesive tapes.

A form of a packing container made from a corrugated sheet product material includes a container having corners that are created by scoring and folding to create a squared off corners. Such containers are efficiently stackable on a pallet with little or no space between adjacently stacked containers. While existing packing containers may be suitable for their intended purpose, the art relating to packing containers made from corrugated sheet product material would be advanced with the inclusion of one or more radiused corners with a smooth outer arc for a more aesthetic appearance.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE INVENTION

An embodiment includes a container, having: a plurality of panels integrally arranged with respect to each other via a plurality of fold lines, score lines, perforated lines, or any combination of fold, score, or perforated lines, the plurality of panels being formed from a corrugated sheet product material and being foldable to create the container; the plurality of panels having a plurality of planar panels, and at least one curved panel; the corrugated sheet product material of the at least one curved panel having an inner facing, an outer facing, and a corrugated material between the inner and outer facings, the corrugated material of the at least one curved panel having flutes; and the inner facing of the at least one curved panel having a plurality of side by side cuts or scores, wherein each of the plurality of side by side cuts or scores pierce at least partially through the inner facing but not through the outer facing; wherein the plurality of side by side cuts or scores extend substantially from one side of the at least one curved panel to substantially an opposing side of the at least one curved panel.

An embodiment includes a flat blank, having: a plurality of panels integrally arranged with respect to each other with a plurality of fold lines, score lines, perforated lines, or any combination of fold, score, or perforated lines, disposed therebetween, the plurality of panels being foldable to form the aforementioned container.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts a rotated perspective view of a container, in accordance with an embodiment;

FIG. 2 depicts a plan view of an inner facing side of a flat blank suitable for forming the container of FIG. 1, in accordance with an embodiment;

FIG. 3 depicts a plan view of an outer facing side of the flat blank of FIG. 2, in accordance with an embodiment;

FIG. 4 depicts a section view along cut line 4-4 depicted in FIG. 3, in accordance with an embodiment;

FIG. 5 depicts a plan view of a portion of an alternative inner facing side of a flat blank suitable for forming the container of FIG. 1, in accordance with an embodiment;

FIG. 6 depicts a plan view of a portion of another alternative inner facing side of a flat blank suitable for forming the container of FIG. 1, in accordance with an embodiment;

FIG. 7 depicts a plan view of a portion of the inner facing side of a flat blank similar to that of FIG. 2, in accordance with an embodiment;

FIG. 8 depicts a plan view of a portion of yet another alternative inner facing side of a flat blank suitable for forming the container of FIG. 1, in accordance with an embodiment;

FIG. 9 depicts a plan view of a portion of a further alternative inner facing side of a flat blank suitable for forming the container of FIG. 1, in accordance with an embodiment;

FIG. 10 depicts a plan view of a portion of yet a further alternative inner facing side of a flat blank suitable for forming the container of FIG. 1, in accordance with an embodiment.

### DETAILED DESCRIPTION OF THE INVENTION

Although the following detailed description contains many specifics for the purposes of illustration, anyone of ordinary skill in the art will appreciate that many variations and alterations to the following details are within the scope of the claims appended hereto. Accordingly, the following example embodiments are set forth without any loss of generality to, and without imposing limitations upon, the claimed invention disclosed herein.

An embodiment, as shown and described by the various figures and accompanying text, provides a flat blank of a corrugated sheet product material and a container formed from the flat blank, where the container has at least one curved panel that forms a corner of the container having a smooth outer arced surface, where the curved panel is created by a plurality of side by side cuts or scores on an inner facing of the corrugated sheet product material, and where the cuts or scores do not extend through the outer facing of the corrugated sheet product material. As used herein, the phrase side by side cuts or scores is intended to encompass cuts or scores that are linear, or cuts or scores that are shaped lines formed by a series of side by side curves, curls, s-shapes, or other shapes, where the shaped lines still produce the desired smooth outer arced surface as disclosed herein.

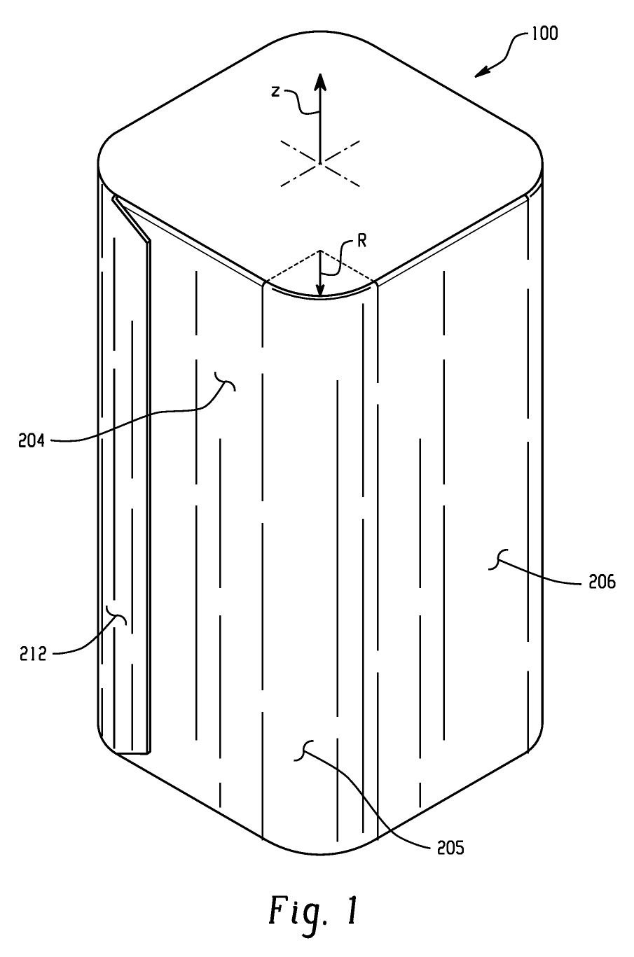

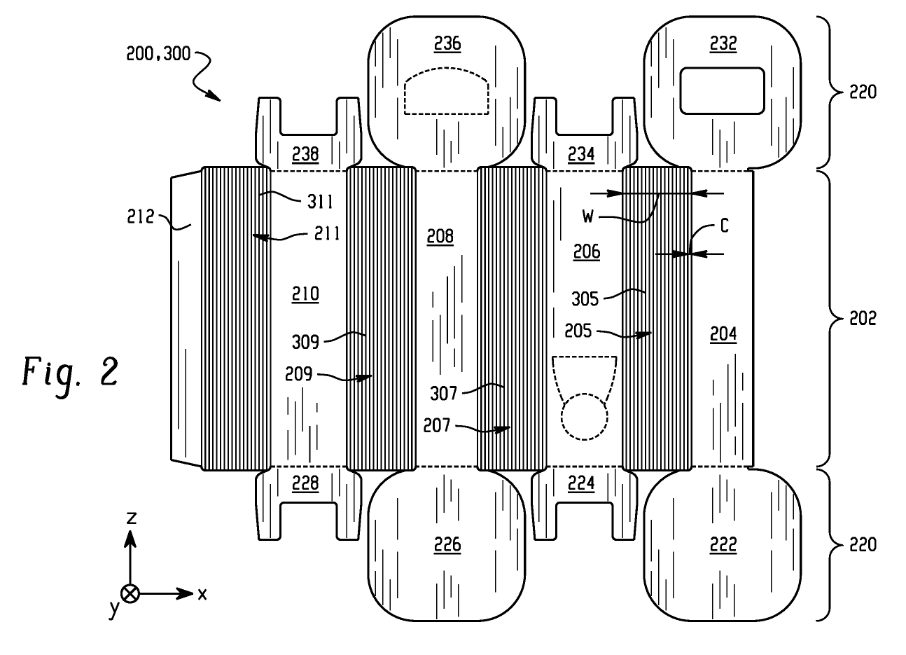

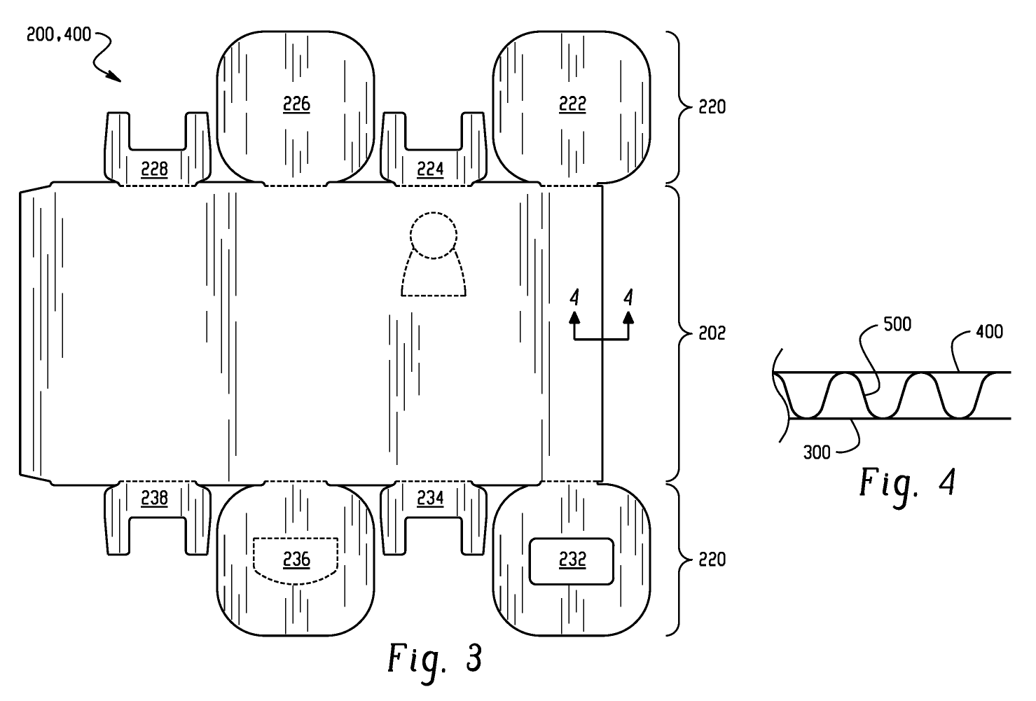

Reference is now made to FIGS. 1-4 collectively, where FIG. 1 depicts a rotated perspective view of a container 100 in accordance with an embodiment, FIG. 2 depicts one side, the inner side and inner facing, of a flat blank 200 suitable for forming the container 100, where features particular to the inner side, inner facing, are referred to by reference numerals 300+, FIG. 3 depicts another side, outer side and outer facing, of the flat blank 200, where features particular to the outer side, outer facing, are referred to by reference numerals 400+, and FIG. 4 depicts a section view along cut line 4-4 depicted in FIG. 3. General features of the flat blank 200 are herein referred to by reference numerals 200+.

In an embodiment, the container 100 includes a plurality of panels 202 integrally arranged with respect to each other via a plurality of fold lines (depicted as dashed lines in FIGS. 2 and 3), score lines (depicted as solid lines in FIGS. 2 and 3), or perforated lines, or any combination of fold, score, or perforated lines, and with respect to a set of orthogonal x, y and z axes, the plurality of panels 202 being formed from a corrugated sheet product material and being foldable to create the container 100. The plurality of panels 202 include a plurality of planar panels 204, 206, 208, 210, 212, and at least one curved panel 205, 207, 209, 211, where an axis of radius of the at least one curved panel is disposed parallel to the z-axis. As depicted in FIG. 4, corrugated sheet product material, and particularly the corrugated sheet product material disclosed herein, has an inner facing 300, an outer facing 400, and a corrugated material 500 between the inner and outer facings. With respect to the container 100 disclosed herein, the corrugated material of the curved panels 205, 207, 209, 211 has flutes oriented parallel with the z axis. Further with respect to the curved panels 205, 207, 209, 211, the inner facing 300 includes a plurality of linear cuts 305, 307, 309, 311 arranged in sets and disposed parallel with each other and parallel with the flutes, where each set of the plurality of linear cuts pierce at least partially through the inner facing 300 but not through the outer facing 400. In an embodiment, the plurality of linear cuts pierce completely through the inner facing 300. In another embodiment, the plurality of linear cuts are replaced with a plurality of linear scores of sufficient depth so as to produce the desired smooth outer arced surface as disclosed herein. In a further embodiment, the plurality of linear cuts are a combination of linear cuts and linear scores that produce the desired smooth outer arced surface as disclosed herein. As depicted in FIG. 2, the four sets of the plurality of planar panels 204, 206, 208, 210, and the four sets of the curved panels 205, 207, 209, 211, are disposed in an alternating arrangement with respect to each other.

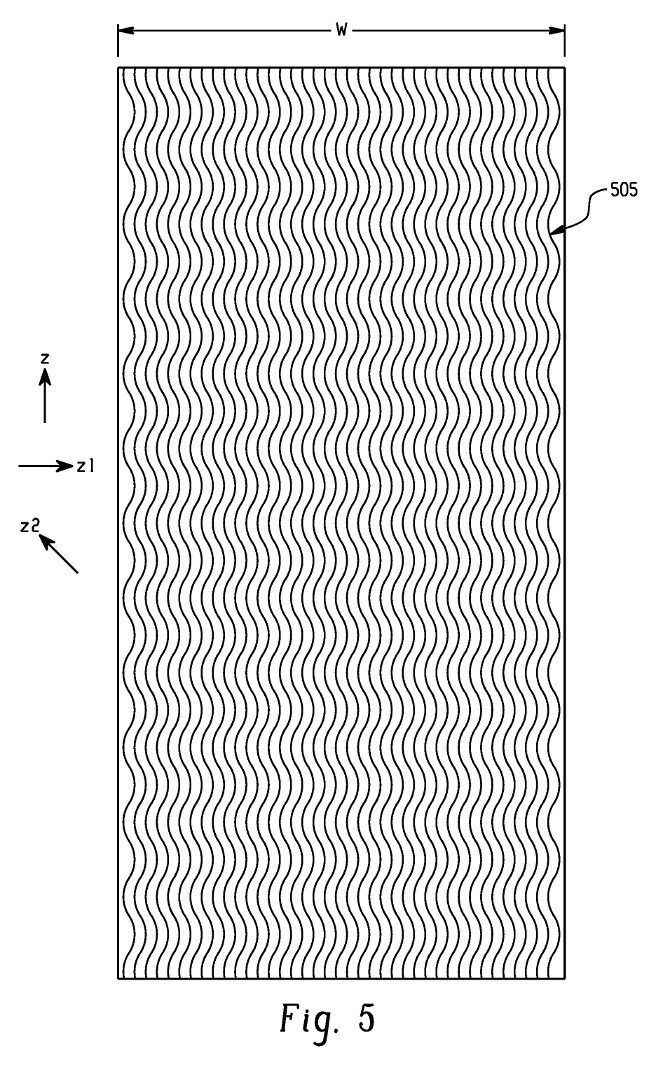

While the embodiment of FIG. 2 depicts the cuts 305, 307, 309, 311 as a plurality of linear cuts, it has been found that the plurality of cuts may in fact not be linear (e.g., a straight line), but may be composed of a plurality of side by side cuts or scores that are not necessarily linear, which are described herein below with reference to FIGS. 5-10. As such, any reference herein to a plurality of linear cuts is also a reference to a plurality of side by side cuts or scores that are not necessarily linear, consistent with a disclosure herein.

In an embodiment, each cut of each set of the plurality of linear cuts 305, 307, 309, 311 are disposed at a distance equal to or less than 0.2 inches and equal or greater than 0.01 inches with respect to each other in the corresponding set, or even closer at a distance equal to or less than 0.13 inches with respect to each other in the corresponding set, see dimension C in FIG. 2 for example. In an embodiment, each cut of each set of the plurality of linear cuts 305, 307, 309, 311 are disposed not necessarily in registration with the flutes. Stated alternatively, a subset of the linear cuts may be disposed out of registration with the flutes, while another subset of the linear cuts may be disposed in registration with the flutes. In an embodiment, each set of the plurality of linear cuts 305, 307, 309, 311 have an overall width W, and the curved panels have a radius of curvature R equal to about 2*W/π. As used herein, the term “equal to about” means “equal to, within acceptable tolerances and accounting for the bending characteristics of the material used”.

As depicted in FIG. 2, an embodiment of the container 100 further includes a plurality of planar side panels that are collectively referred to by reference numeral 220, and individually referred to by reference numerals 222, 224, 226, 228, 232, 234, 236, 238, where a pair of the plurality of planar side panels are contiguous with a corresponding one of the plurality of planar panels, see for example: side panel pairs 222, 232 and planar panel 204; side panel pairs 224, 234 and planar panel 206; side panel pairs 226, 236 and planar panel 208; and, side panel pairs 228, 238 and planar panel 210.

As depicted in the various figures provided herewith, an embodiment of the container 100 includes an arrangement where the plurality of planar panels 204, 206, 208, 210 consists of at least four planar panels with a fifth planar panel 212 being used as an adhesion panel that is adhered to planar panel 204 in the folded and assembled state, and where the at least one curved panel consists of at least two, or alternatively four, of the at least one curved panel, see panels 205, 207, 209, 211, for example.

In accordance with an embodiment, a flat blank 200 is disclosed herein having a plurality of panels 202, 220 integrally arranged with respect to each other with a plurality of fold lines (depicted as dashed lines in FIGS. 2 and 3), score lines (depicted as solid lines in FIGS. 2 and 3), or perforated lines, or any combination of fold, score, or perforated lines, disposed therebetween, the plurality of panels being foldable to form the container 100. In connection with the description of the container 100 herein above, the plurality of planar panels include a first plurality of panels 204, 206, 208, 210, and a second plurality of panels 205, 207, 209, 211, the first plurality of panels being foldable to form the plurality of planar panels 204, 206, 208, 210, and the second plurality of panels being foldable to form the curved panels 205, 207, 209, 211. Other structural features of the flat blank 200 as disclosed herein are consistent with the description of the container 100 herein above that is formed from the flat blank 200. With respect to FIGS. 2 and 3, it will be noted that the plurality of linear cuts 305, 307, 309, 311 are present on the inner facing 300 only as depicted in FIG. 2, but not the outer facing 400 as depicted in FIG. 3, which provides the desired degree of formability of the flat blank 200 to form the container 100 with smooth arced outer corners. In an embodiment, the flat blank 200 is formed around a mandrel to form the container 100.

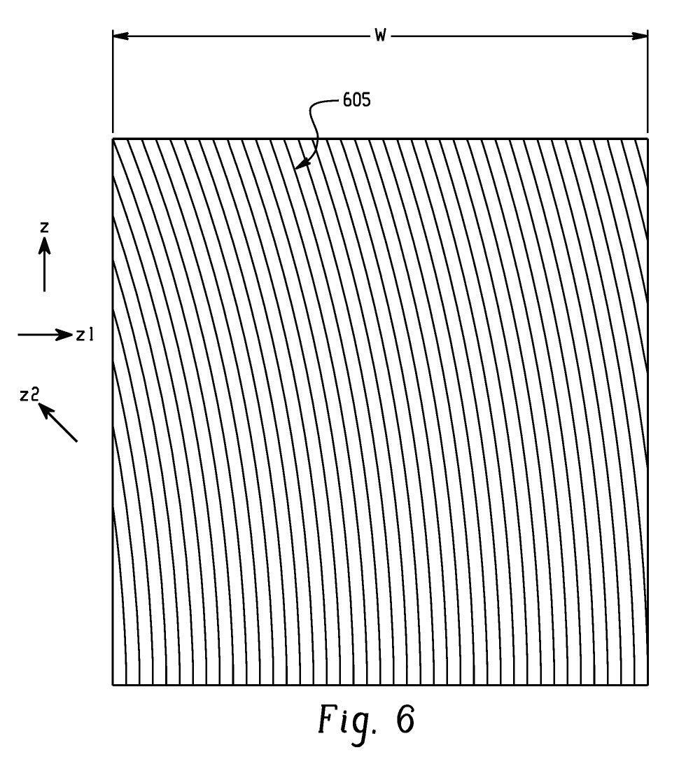

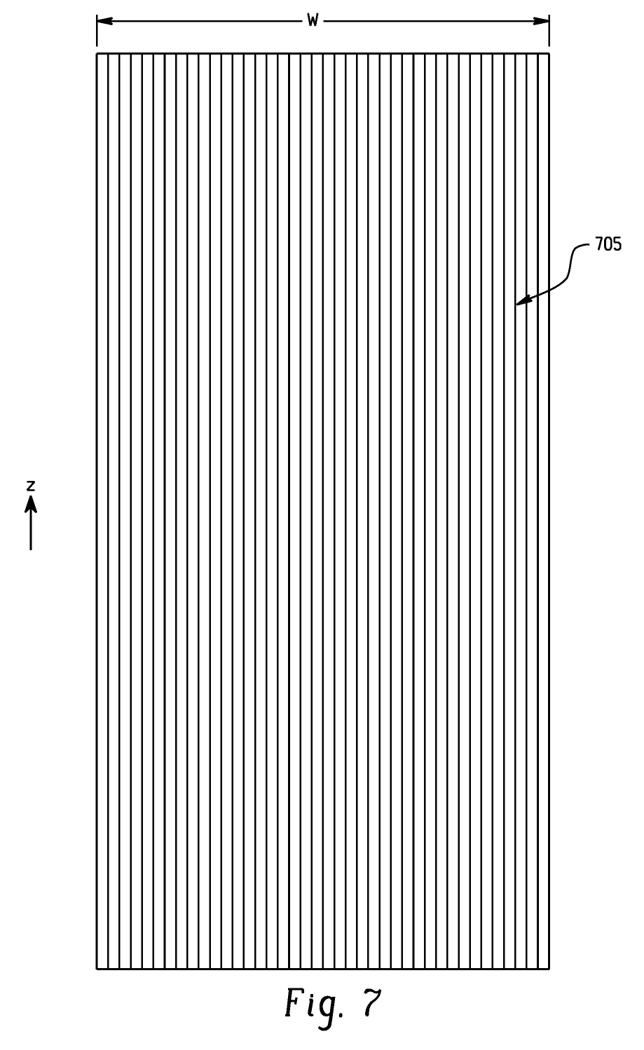

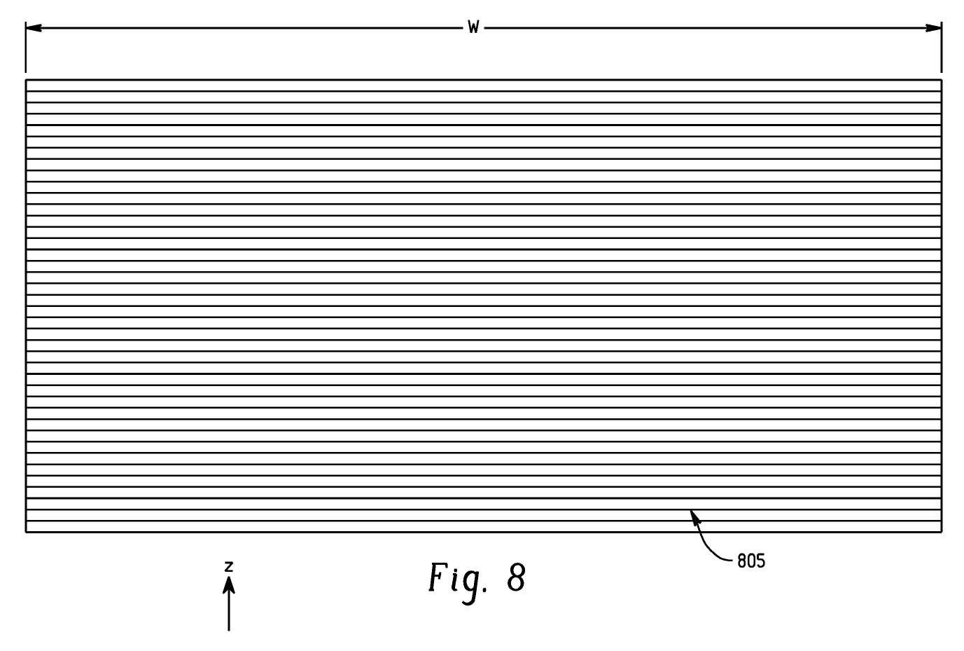

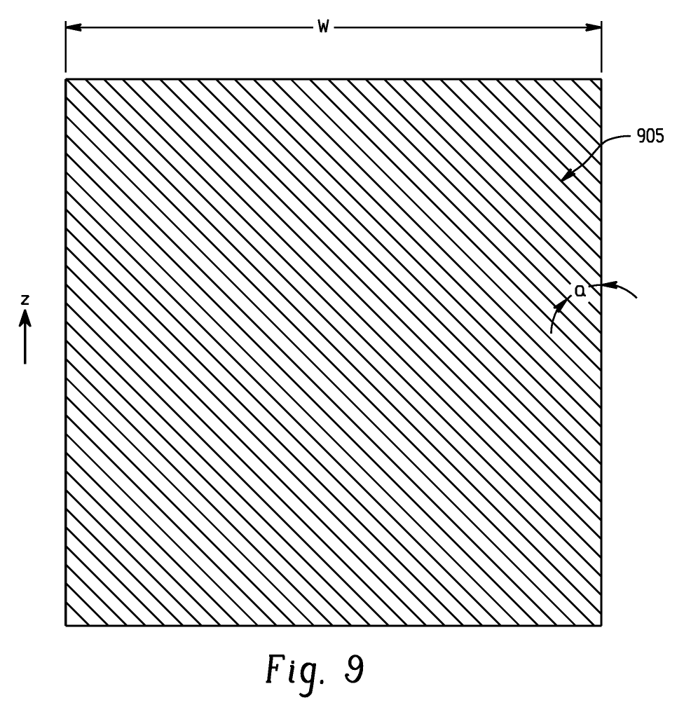

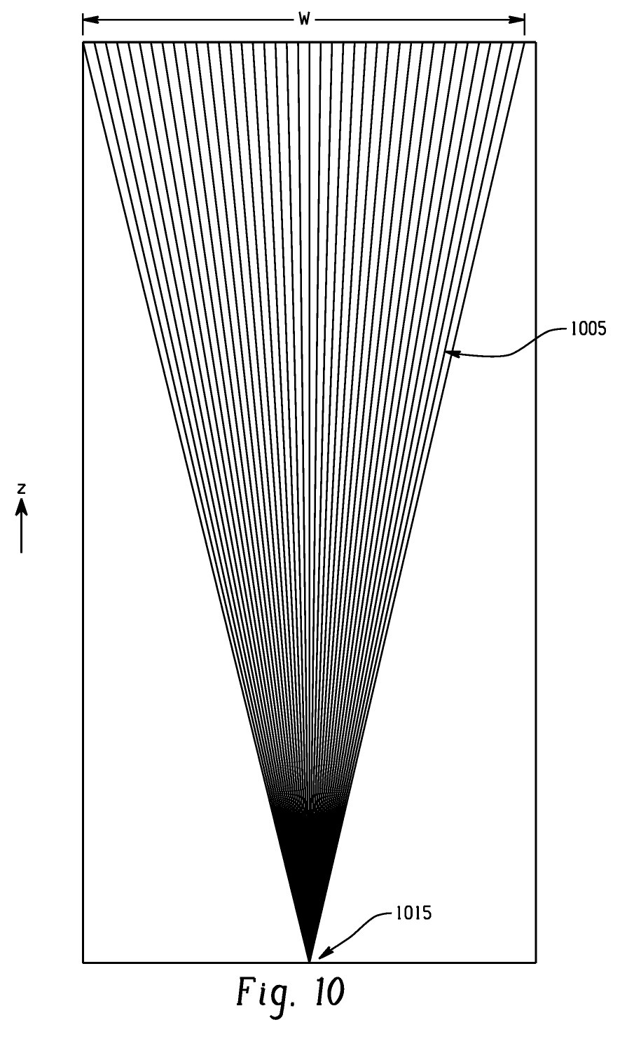

As noted herein above, a scope of the invention is not limited to a plurality of linear cuts 305, 307, 309, 311, but also encompasses a plurality of side by side cuts or scores, which are now described with reference to FIGS. 5-10. In FIG. 5, each of the plurality of side by side cuts or scores 505 is an s-shaped line oriented along the direction of the flutes (z-direction). FIG. 5 also depicts each of the plurality of side by side cuts or scores 505 being an s-shaped line oriented along a direction perpendicular to the flutes (z1-direction), and further depicts each of the plurality of side by side cuts or scores 505 being an s-shaped line oriented along a direction at an angle to the flutes (z2-direction). In FIG. 6, each of the plurality of side by side cuts or scores 605 is an arc-shaped line that traverses the direction of the flutes in a first direction (z-direction). FIG. 6 also depicts each of the plurality of side by side cuts or scores 605 being an arc-shaped line that traverses the direction of the flutes in a second direction (z1-direction), and further depicts each of the plurality of side by side cuts or scores 605 being an arc-shaped line that traverses the direction of the flutes at an angle to the flutes in a third direction (z2-direction). In FIG. 7, each of the plurality of side by side cuts or scores 705 is a linear line oriented parallel to the flutes (z-direction), similar to the plurality of linear cuts 305 depicted in FIG. 2. In FIG. 8, each of the plurality of side by side cuts or scores 805 is a linear line oriented perpendicular to the flutes (z-direction). In FIG. 9, each of the plurality of side by side cuts or scores 905 is a linear line oriented at an angle “a” to the flutes (z-direction). In FIG. 10, each of the plurality of side by side cuts or scores 1005 is a linear line oriented at an angle relative to the flutes (z-direction), wherein the plurality of side by side cuts or scores 1005 have a common point 1015 of intersection at the one side of the at least one curved panel, and fan out to an overall width W at the opposing side of the at least one curved panel.

By varying the shape of the side by side cuts or scores from a linear line to a non-linear line (e.g., s-shaped or arc-shaped), or by varying the orientation of the side by side cuts or scores from being parallel with the flutes, or z-direction, to being non-parallel with the flutes, or z1 or z2-direction (e.g., perpendicular to the flutes, at an angle to the flutes, or in a fanned arrangement relative to the flutes), unexpected advantages were found. For example, it was unexpectedly found that the s-shaped plurality of side by side cuts or scores 505 as depicted in FIG. 5 performed better than any other configuration disclosed herein for forming a smooth outer arced surface, panel 205, of the container 100 for a purpose disclosed herein, for all orientations of the s-shaped plurality of side by side cuts or scores 505 (e.g., relative to the z-direction, z1-direction, or z2-direction). It was also unexpectedly found that the arc-shaped plurality of side by side cuts or scores 605 as depicted in FIG. 6 performed better than the linear plurality of side by side cuts or scores 705 as depicted in FIG. 7, for all orientations of the arc-shaped plurality of side by side cuts or scores 605 (e.g., relative to the z-direction, z1-direction, or z2-direction). It was also unexpectedly found that linear plurality of side by side cuts or scores 805 as depicted in FIG. 8 oriented perpendicular to the z-direction performed acceptably for forming a smooth outer arced surface, panel 205, of the container 100 for a purpose disclosed herein. It was further unexpectedly found that a fan shaped plurality of side by side cuts or scores 1005 performed acceptably for forming a funnel or wave-shaped smooth outer surface of the container 100. It was yet further unexpectedly found that both the s-shaped cuts or scores 505 and the arc-shaped cuts or scores 605, when disposed substantially parallel to the flutes (z-direction), appeared to provide a smooth outer surface, panel 205, of the container 100 that exhibited a stronger resistance to squeeze and/or deformation when exposed to an external load.

While not being held to any particular theory, it is contemplated that both the s-shaped cuts 505 or scores and the arc-shaped cuts or scores 605 perform better than the other configurations of cuts or scores because when run substantially parallel to the flutes (z-direction) there is no opportunity for the cuts or scores to fall between the flutes, and correspondingly no opportunity to produce a false score and create a flat spot, thereby forming a smoother outer arced surface, panel 205, of the container 100.

In an embodiment, the corrugated sheet product material disclosed and used herein is a single wall corrugated sheet product material, not a double wall or triple wall material, and may be a micro-flute, a B-flute, or a C-flute, corrugated sheet product material. However, it has been found that some of the side by side cuts or scores disclosed herein produce a smooth outer arced surface (on panel 205 for example) with micro-flutes, but not as smooth with B-flutes or C-flutes. That said, some degree of undulation on the outer arced surface of panel 205 may be acceptable in some applications using B-flutes or C-flutes. As noted above, the s-shaped plurality of side by side cuts or scores 505 as depicted in FIG. 5 performed better than any other configuration disclosed herein for forming a smooth outer arced surface on panel 205, which was found to be acceptably smooth for micro-flutes, B-flutes, and C-flutes.

In an embodiment, the plurality of side by side cuts or scores, any of which as disclosed herein, extend substantially from one side of the at least one curved panel to substantially an opposing side of the at least one curved panel. As used herein, the phrase “extend substantially from one side of the at least one curved panel to substantially an opposing side of the at least one curved panel” means that the plurality of side by side cuts or scores extend from within about ⅛ inch of an edge of the at least one curved panel to within about ⅛ inch of an opposing edge of the at least one curved panel, as it has been found that the side by side cuts or scores may not necessarily extend all the way to opposing edges of the at least one curved panel in order to produce a desired curvature of the at least one curved panel.

While the planar panels, curved panels, and planar side panels, are disclosed herein having a defined and illustrated geometry, it will be appreciated that this is for illustration purposes only, and is not limiting to the scope of the invention disclosed herein. As such, any geometry for the panels disclosed herein that is commensurate with the appended claims is contemplated and considered to fall within the ambit of the invention disclosed herein.

While an invention has been described herein with reference to example embodiments, it will be understood by those skilled in the art that various changes may be made and equivalents may be substituted for elements thereof without departing from the scope of the claims. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Additionally, the term “comprising” as used herein does not exclude the possible inclusion of one or more additional features.

What is claimed is:

1. A container, comprising:
a plurality of panels integrally arranged with respect to each other via a plurality of fold lines, score lines, perforated lines, or any combination of fold, score, or perforated lines, the plurality of panels being formed from a corrugated sheet product material and being foldable to create the container;
the plurality of panels comprising a plurality of planar panels, and at least one curved panel;
the corrugated sheet product material of the at least one curved panel having an inner facing, an outer facing, and a corrugated material between the inner and outer facings, the corrugated material of the at least one curved panel comprising flutes; and
the inner facing of the at least one curved panel comprising a plurality of side by side cuts or scores, wherein each of the plurality of side by side cuts or scores pierce at least partially through the inner facing but not through the outer facing;
wherein the plurality of side by side cuts or scores extend substantially from one side of the at least one curved panel to substantially an opposing side of the at least one curved panel.

2. The container of claim 1, wherein the plurality of side by side cuts or scores pierce completely through the inner facing.

3. The container of claim 1, wherein the plurality of side by side cuts or scores are disposed at a distance equal to or less than 0.2 inches and equal to or greater than 0.01 inches with respect to each other.

4. The container of claim 1, wherein the plurality of side by side cuts or scores are disposed at a distance equal to or less than 0.13 inches and equal to or greater than 0.01 inches with respect to each other.

5. The container of claim 1, wherein the corrugated sheet product material is a single wall corrugated sheet product material.

6. The container of claim 1, wherein the corrugated sheet product material is a Micro-flute or a B-flute corrugated sheet product material.

7. The container of claim 1, wherein the corrugated sheet product material is a micro-flute corrugated sheet product material.

8. The container of claim 1, wherein at least some of the plurality of side by side cuts or scores are disposed out of registration with the flutes.

9. The container of claim 1, wherein the plurality of side by side cuts or scores are disposed within a rectangular region having an overall width W, and the at least one curved panel has a radius of curvature equal to about 2*W/π.

10. The container of claim 1, wherein the plurality of planar panels and the at least one curved panel are disposed in an alternating arrangement with respect to each other.

11. The container of claim 1, further comprising a plurality of planar side panels, wherein a pair of the plurality of planar side panels are contiguous with a corresponding one of the plurality of planar panels.

12. The container of claim 1, wherein the plurality of planar panels comprises at least four planar panels, and the at least one curved panel comprises at least two of the at least one curved panel.

13. The container of claim 12, wherein the at least one curved panel comprises four of the at least one curved panel.

14. The container of claim 1, wherein each of the plurality of side by side cuts or scores is an s-shaped line oriented along the direction of the flutes.

15. The container of claim 1, wherein each of the plurality of side by side cuts or scores is an arc-shaped line that traverses the direction of the flutes.

16. The container of claim 1, wherein each of the plurality of side by side cuts or scores is a linear line oriented parallel to the flutes.

17. The container of claim 1, wherein each of the plurality of side by side cuts or scores is a linear line oriented perpendicular to the flutes.

18. The container of claim 1, wherein each of the plurality of side by side cuts or scores is a linear line oriented at an angle to the flutes.

18. The container of claim 1, wherein each of the plurality of side by side cuts or scores is a linear line oriented at an angle relative to the flutes, wherein the plurality of side by side cuts or scores have a common point of intersection at the one side of the at least one curved panel, and fan out to an overall width W at the opposing side of the at least one curved panel.

19. The container of claim 1, wherein side by side ones of the plurality of side by side cuts or scores have a uniform sideways spacing with respect to each other.

20. The container of claim 18, wherein side by side ones of the plurality of side by side cuts or scores have a uniform angular spacing with respect to each other.

21. A flat blank, comprising:
a plurality of panels integrally arranged with respect to each other with a plurality of fold lines, score lines, perforated lines, or any combination of fold, score, or perforated lines, disposed therebetween, the plurality of panels being foldable to form the container of claim 1.

22. The flat blank of claim 21, wherein:
the plurality of planar panels comprise a first plurality of panels and at least one second panel;
the first plurality of panels being foldable to form the plurality of planar panels; and
the at least one second panel being foldable to form the at least one curved panel.

23. The flat blank of claim 22, wherein the plurality of side by side cuts or scores are disposed at a distance equal to or less than 0.2 inches and equal to or greater than 0.01 inches with respect to each other.

24. The flat blank of claim 22, wherein the plurality of side by side cuts or scores are disposed at a distance equal to or less than 0.13 inches and equal to or greater than 0.01 inches with respect to each other.

25. The flat blank of claim 22, wherein the corrugated sheet product material is a single wall corrugated sheet product material.

26. The flat blank of claim 22, wherein the corrugated sheet product material is a Micro-flute or a B-flute corrugated sheet product material.

27. The flat blank of claim 22, wherein the corrugated sheet product material is a micro-flute corrugated sheet product material.

28. The flat blank of claim 22, wherein at least some of the plurality of side by side cuts or scores are disposed out of registration with the flutes.

29. The flat blank of claim 22, wherein the plurality of side by side cuts or scores have an overall width W, and the at least one curved panel in the folded state has a radius of curvature equal to about 2*W/π.

30. The flat blank of claim 22, wherein the plurality of planar panels and the at least one curved panel are disposed in an alternating arrangement with respect to each other.
